(19) United States
(12) Patent Application Publication
(10) Pub. No.: US 2024/0146173 A1
(43) Pub. Date: May 2, 2024

(54) SWITCHED MODE POWER SUPPLY

(71) Applicant: TEXAS INSTRUMENTS INCORPORATED, Dallas, TX (US)

(72) Inventors: Jing Ji, HANGZHOU (CN); Jian Liang, SHANGHAI (CN)

(21) Appl. No.: 17/975,391

(22) Filed: Oct. 27, 2022

(51) Int. Cl. H02M 1/00; H02M 3/157

(52) U.S. Cl. CPC H02M 1/0029; H02M 1/0009; H02M 1/0012; H02M 3/157

(57) ABSTRACT

In one example, an apparatus comprises an amplifier, a ramp generation circuit, and a comparator. The amplifier has a reference input, a power converter feedback input, and an amplifier output. The ramp generation circuit has a ramp slope control terminal and a ramp signal terminal, the ramp slope control terminal coupled to the amplifier output. The comparator has a current sense input, a ramp signal input, and a comparator output, in which the ramp signal input is coupled to the ramp signal terminal, and the comparator output is coupled to a power converter control terminal.

### BACKGROUND

A switched mode power supply (SMPS) uses semiconductor switching techniques to transfer power from an input power source to a load. The SMPS may include an energy storage element (such as an inductor, a capacitor, a transformer, etc.) and switches. Through the operation of the switches, the energy storage element can continuously switch between a charging state and a discharging state in each switching cycle. A controller of the SMPS can determine the on-time and off-time of the switches, which can reflect the time durations of the charging and discharging states in a switching cycle, so the SMPS can provide a desired power to the load.

### SUMMARY

An apparatus comprises an amplifier, a ramp generation circuit, and a comparator. The amplifier has a reference input, a power converter feedback input, and an amplifier output. The ramp generation circuit having a ramp slope control terminal and a ramp signal terminal, the ramp slope control terminal coupled to the amplifier output. The comparator has a current sense input, a ramp signal input, and a comparator output, in which the ramp signal input is coupled to the ramp signal terminal, and the comparator output is coupled to a power converter control terminal.

An apparatus comprises a power converter and a controller. The power converter has a power input, a power output, a current sense output, and a control input. The controller has a control output, a feedback voltage input, a reference voltage input, and a current sense input. The control output is coupled to the control input. The feedback voltage input is coupled to the power output. The current sense input is coupled to the current sense output. The controller includes an amplifier, a ramp generation circuit, and a comparator. The amplifier has an amplifier output and first and second amplifier inputs, the first amplifier input coupled to the reference voltage input, and the second amplifier input coupled to the feedback voltage input. The ramp generation circuit has a ramp slope control terminal and a ramp signal terminal, the ramp slope control terminal coupled to the amplifier output. The comparator has a comparator output and first and second comparator inputs, the first comparator input coupled to the current sense input, the second comparator input coupled to the ramp signal terminal, and the comparator output coupled to the control output.

In a method, a current sense signal representing a current through a switch of a power converter is received. An error signal indicating a load condition is generated. Responsive to the error signal indicating that a light load condition is satisfied: a ramp signal having a ramp rate based on the error signal is generated. A current target signal is generated based on subtracting the ramp signal from the error signal. The current target signal is compared with the current sense signal to generate a decision. And a switching signal is provided to the power converter responsive to the decision.

### BRIEF DESCRIPTION OF THE DRAWINGS

FIG. 1 includes schematics of examples of switched mode power supplies (SMPS).

FIG. 2, FIG. 3, FIG. 4, and FIG. 5 are graphs that illustrate example operations of an SMPS.

FIG. 6, FIG. 7, and FIG. 8 are graphs that illustrate example operations of an SMPS.

FIG. 9 is a schematic that illustrates an example controller of an SMPS.

FIG. 10, FIG. 11, and FIG. 12 are graphs that illustrate example operations of an SMPS and the controller of FIG. 9.

FIG. 13 and FIG. 14 are schematics of example internal components of the controller of FIG. 9.

FIG. 15, FIG. 16, and FIG. 17 are graphs that illustrate example operations of an SMPS and the controller of FIG. 9.

FIG. 18 are graphs that illustrate example efficiency properties of an SMPS under different control schemes.

FIG. 19 is a flowchart of an example method of operating an SMPS.

The same reference numbers or other reference designators are used in the drawings to designate the same or similar (functionally and/or structurally) features.

### DETAILED DESCRIPTION

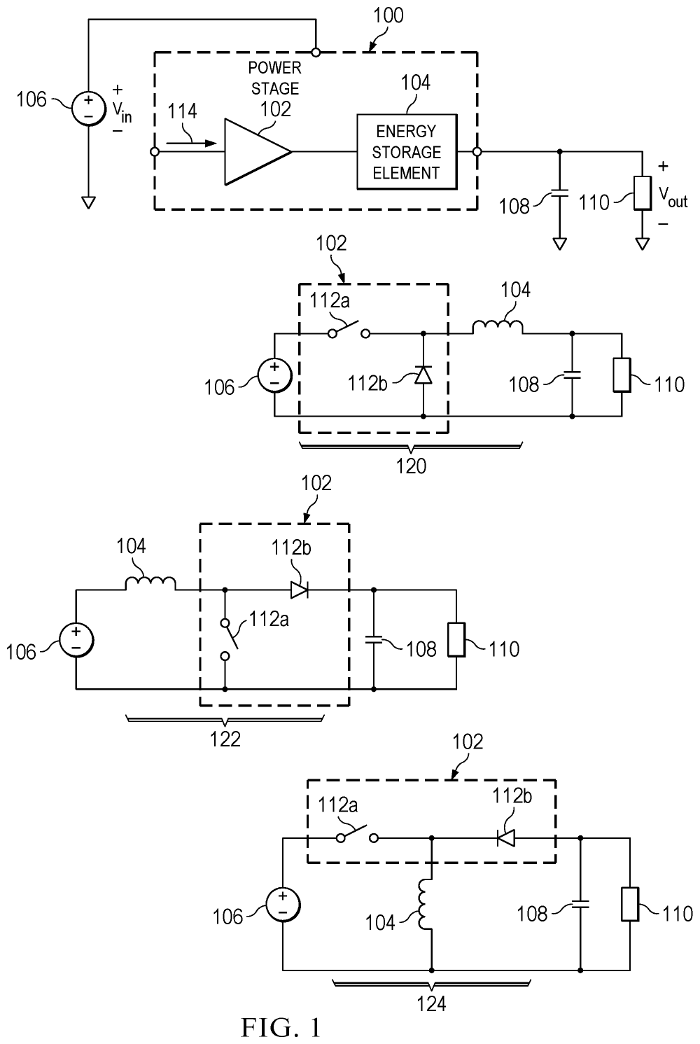

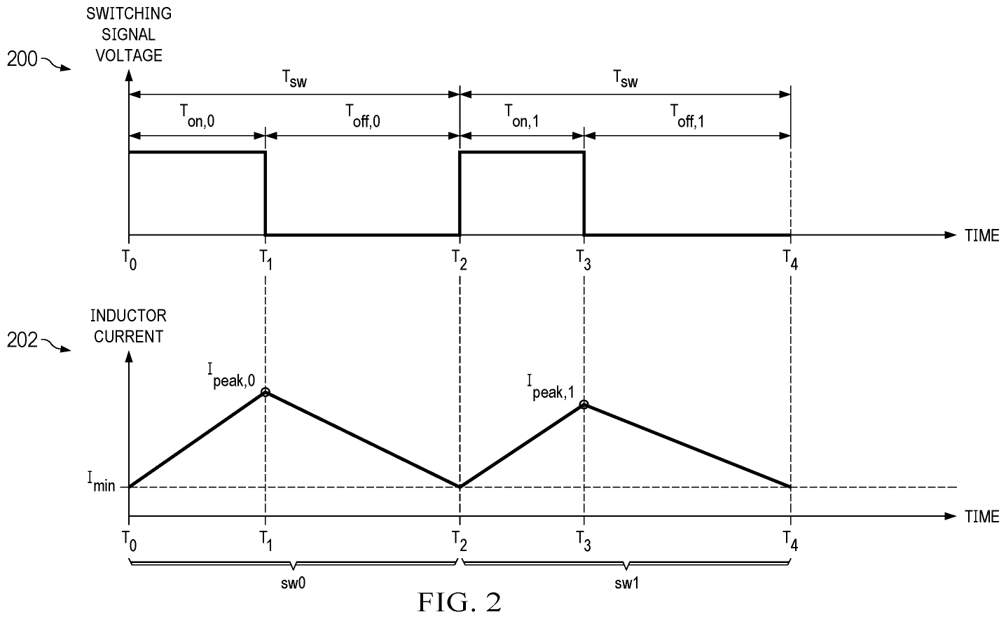

FIG. 1 illustrates schematics of examples of a switched mode power supply (SMPS) 100. Referring to the first schematic of FIG. 1, SMPS 100 can include a power stage 102 and an energy storage element 104 coupled between a power source 106, a capacitor 108, and a load 110. Power source 106 can provide an input voltage (labelled “Vᵢₙ” in FIG. 1) to SMPS 100. Power stage 102 can include switches 112a and 112b. Switch 112a can include a transistor such as a field effect transistor (FET). Switch 112b can be configured as a rectifier switch and can include a diode, or a transistor (e.g., a FET) if switch 112b is a synchronous switch. Energy storage element 104 can include, for example, an inductor, a capacitor, or a transformer. Power stage 102 can receive a switching signal 114 that can switch the states of switch 112a and switch 112b. Through the switching of switches 112a and 112b, energy storage element 104 can switch between a charging state in which energy storage element 104 stores energy received from power source 106, and a discharging state in which energy storage element 104 provides the stored energy, in the form of an output voltage (labelled “Vₒᵤₜ” in FIG. 1) and an output current, to load 110. Capacitor 108 can smooth out the ripples of the output voltage. Other schematics of FIG. 1 illustrate example configurations of power stage 102 and energy storage element 104, such as a buck converter 120, a boost converter 122, and a buck-boost converter 124, where energy storage element 104 can be an inductor.

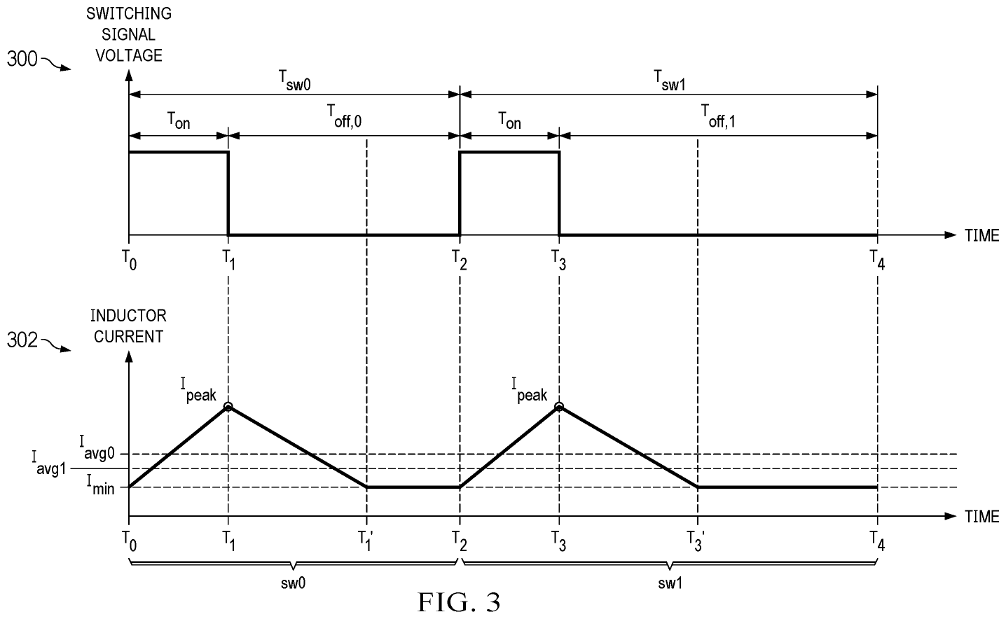

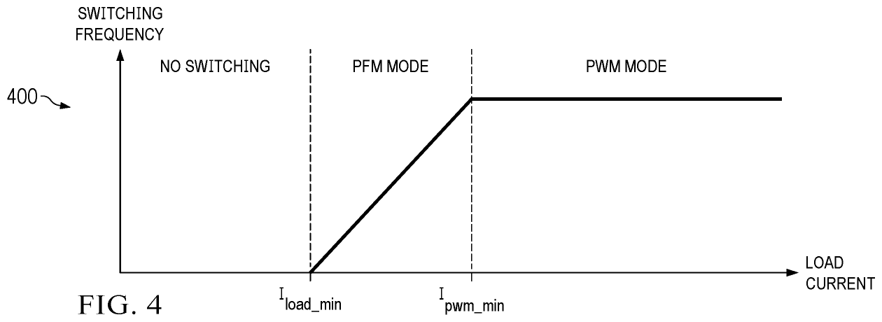

FIG. 2 and FIG. 3 are waveform graphs that illustrate example operations of SMPS 100. In FIG. 2, graph 200 is a plot of a voltage of switching signal 114 with respect to time, and graph 202 is a plot of a current conducted by energy storage element (e.g., inductor) 104. Graph 200 illustrates two example switching cycles of switching signal 114 labelled sw0 and sw1. Switching cycle sw0 spans from time T₀ to T₂, and switching cycle sw1 spans from time T₂ to T₄. Switching cycle sw0 has an on-time T_{on,0} between T₀ and T₁ in which inductor 104 is in a charging state, and an off-time T_{off,0} between T₁ and T₂ in which inductor 104 is in a discharging state. Also, switching cycle sw1 has an on-time T_{on,1} between T₂ and T₃ in which inductor 104 is in the charging state again, and an off-time T_{off,1} between T₃ and T₄ in which inductor 104 is in the discharging state again.

Inductor 104 can be in the charging state when power stage 102 is enabled, which includes switch 112a being turned on and switch 112b being turned off. When inductor 104 is in the charging state, inductor 104 can receive a current from power source 106, and the current increases from a non-negative minimum current Iₘᵢₙ to a peak current Iₚₑₐₖ with respect to time as magnetic energy is stored in inductor 104. The rate of increase of the inductor current within the on-time can be based on a voltage across inductor 104, which can be based on the input voltage Vᵢₙ.

Inductor 104 can be in a discharging state when power stage 102 is disabled, which includes switch 112a being turned off and switch 112b being turned on. When inductor 104 is in the discharging state, inductor 104 can release the stored magnetic energy and provides a current, which decreases from Iₚₑₐₖ back to Iₘᵢₙ with respect to time. The rate of decrease of the inductor current within the off-time can be based on a voltage across inductor 104, which can be based on the output voltage Vₒᵤₜ.

The duration of on-time within a switching cycle can affect the peak current and the amount of magnetic energy stored in inductor 104, which can also affect the energy provided by inductor 104 to load 110. For example, in FIG. 2, the on-time T_{on,0} of switching cycle sw0 can be longer than the on-time T_{on,1} of switching cycle sw1, and the peak current I_{peak,0} in switching cycle sw0 can become larger than the peak current I_{peak,1} in switching cycle sw1. Accordingly, inductor 104 can provide more energy to load 110 in switching cycle sw1 than in switching cycle sw2. Also, the duty cycle of a switching cycle, which can be defined by a ratio between the on-time duration and the cycle period duration, can determine the ratio between the input voltage Vᵢₙ and the output voltage Vₒᵤₜ.

In some examples, SMPS 100 can be controlled by a controller that implements a feedback system to regulate the on-time and off-time of the switching cycles, such that the SMPS can provide a desired voltage and/or a desired current to the load. Specifically, the controller can receive measurements of the current conducted by inductor 104, and measurements of the voltage provided by SMPS 100. Based on comparing the current conducted by inductor 104 and a desired/target current value, the controller can adjust the on-time of the switching cycle, which can also adjust the duration of the charging state of inductor 104 within the switching cycle as well as the peak inductor current. Also, based on comparing the voltage provided by SMPS 100 and a reference voltage, the controller can adjust the on-time and/or the duty cycle of the switching cycle to regulate the output voltage of SMPS 100 at the reference voltage.

The controller can set the on-time and off-time of a switching cycle based on various techniques, including pulse width modulation (PWM) and pulse frequency modulation (PFM). With PWM, the switching cycle period as well as the switching frequency can be kept constant. Due to the constant switching frequency, PWM can provide a predictable operating frequency and low output ripple characteristics. SMPS 100 can also operate with high efficiency during heavy load conditions where the switching loss incurred by power stage 102 can be small compared with the amount of power transferred to load 110. The controller can adjust the on-time of the switching cycle to adjust the peak inductor current as well as the output voltage. The operation in FIG. 2 can be a PWM mode of operation. In FIG. 2, switching cycles sw0 and sw1 can have the same cycle period T_{sw}. In switching cycle sw0, the controller can set the on-time T_{on,0} to obtain a peak inductor current of I_{peak,0}. In switching cycle sw1, the controller can set a different on-time T_{on,1} to obtain a different peak inductor current of I_{peak,1}.

The controller can also set the on-time and off-time of a switching cycle based on PFM. With PFM, the controller can maintain the on-time at a constant, and adjust the switching frequency to adjust the power provided to the load. PFM can improve the efficiency of SMPS when operating in a low load condition or a standby condition. In such conditions, as the demand for current from the load is reduced to close to zero, the switching frequency can be reduced. The switching loss incurred by power stage 102 can be reduced compared with the power being transmitted by SMPS 100, which can improve the efficiency of the SMPS. Also, because the switching frequency is reduced, the average inductor current can be reduced to match the reduced current demand of the load.

FIG. 3 includes graphs that illustrate example operations of SMPS 100 in the PFM mode. In FIG. 3, graph 300 is a plot of the voltage of switching signal 114 with respect to time, and graph 302 is a plot of the current conducted by inductor 104. Two switching cycles (sw0 and sw1) are shown in FIG. 3. With PFM, the controller can maintain the on-time while adjusting the off-time of the switching cycles. For example, in FIG. 3, both switching cycles sw0 and sw1 have identical on-time Tₒₙ which can lead to identical peak inductor current Iₚₑₐₖ. But switching cycles sw0 and sw1 can have different respective off-times T_{off,0} and T_{off,1}. Within each off-time, the inductor current can drop from Iₚₑₐₖ to a minimum current Iₘᵢₙ (e.g., zero) and stay at Iₘᵢₙ for a certain duration. For example, in switching cycle sw0, inductor 104 conducts the minimum current Iₘᵢₙ between T₁′ to T₂, and in switching cycle sw1, inductor 104 conducts the minimum current Iₘᵢₙ between T₃′ to T₃. In a case where Iₘᵢₙ is zero, both switches 112a and 112b can be turned off. Due to the different durations of Iₘᵢₙ, the average current can be different between the switching cycles. In FIG. 3, as T_{off,1} of sw1 is longer than T_{off,0} of sw0, the average current I_{avg0} of sw0 can be higher than the average current I_{avg1} of sw1. The controller can increase T_{off,1} to reduce the average current provided to load 110 within switching cycle sw1 according to the reduced demand for current from load 110. The duty cycle of the switching signals, which changes with the off-time, can also set the output voltage Vₒᵤₜ of SMPS 100.

FIG. 4 includes a graph 400 that illustrates the variation of switching frequency of SMPS 100 with respect to load current. Referring to graph 400, if the load current is below a minimum load current I_{load_min}, SMPS 100 can stop switching. Also, to supply a current above I_{load_min} but below a PWM threshold I_{pwm_min} to the load, SMPS 100 can operate in the PFM mode, and the switching frequency increases with the load current. Also, if the load current is above I_{pwm_min}, SMPS 100 can operate in the PWM mode with a constant switching frequency. SMPS 100 can adjust the on-time of a switching cycle to adjust the load current.

Although operating SMPS 100 in the PFM mode can improve the efficiency of the power converter in light load condition, the variable switching frequency in the PFM mode can worsen the electromagnetic interference (EMI) between SMPS 100 and other electronic components. Specifically, because the switching frequency varies with the load current, to support a wide range of load current SMPS 100 may also have a wide switching frequency range in the PFM mode. Accordingly, SMPS 100 may have a fundamental switching frequency, or its harmonics, that is close to the operation frequency of other electronic components in supplying a particular load current, and may violate EMI requirements for those components. For example, various Automotive Electromagnetic Compatibility (EMC) Test Standards, such as Comité International Spécial des Perturbations Radioelectriques (CISPR), contains thresholds for radio disturbances across various frequency ranges. SMPS 100 operating in the PFM mode may emit an electromagnetic signal having a fundamental frequency (or harmonic frequencies) that falls within those frequency ranges, and having power that exceeds the threshold defined in the CISPR standards. Accordingly, SMPS 100 operating in the PFM mode under certain load conditions may fail the CISPR standards and may not be suitable for automotive applications.

In some examples, SMPS 100 may also operate in a forced PWM (FPWM) mode in light load condition. The switching frequency of SMPS 100 in the PWM mode can be selected to conform certain EMI requirements (e.g., CISPR). FIG. 5 includes graphs that illustrate example operations of SMPS 100 in the FPWM mode in a light load condition. In FIG. 5, graph 500 is a plot of the current conducted by inductor 104, and graph 502 is a plot of the voltage of switching signal 114 with respect to time. Referring to graph 502, SMPS 100 can switch at a constant frequency, and the switching cycles can have a constant cycle period T_{sw}. Also, within a switching cycle, the off-time T_{off} is extended to allow the inductor current to reach a negative minimum value Iₘᵢₙ during the discharging of the inductor, followed by the on-time Tₒₙ of the subsequent cycle where the inductor current increases from Iₘᵢₙ to a positive peak value Iₚₑₐₖ. A controller can set the negative minimum inductor current Iₘᵢₙ and positive peak inductor current Iₚₑₐₖ by adjusting the on-time Tₒₙ and/or off-time T_{off} of a switching cycle.

In the FPWM operations of FIG. 5, the average current I_{avg} supplied to the load can be reduced due to the negative inductor current, while the switching frequency can be selected to conform to the EMI requirements. However, the conduction of negative inductor current in each switching cycle, which consumes significant amount of power, can significantly degrade the efficiency of SMPS 100. The efficiency of SMPS 100 can become very low in the light load condition where the negative current is comparable to or even exceed the load current.

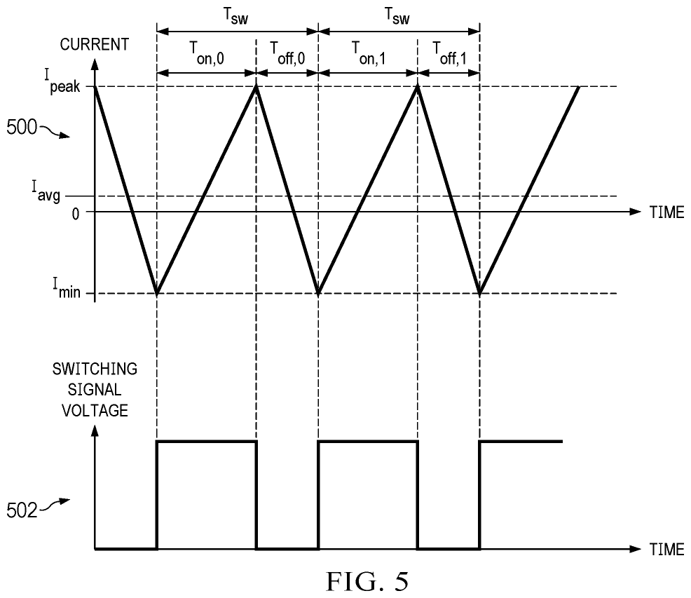

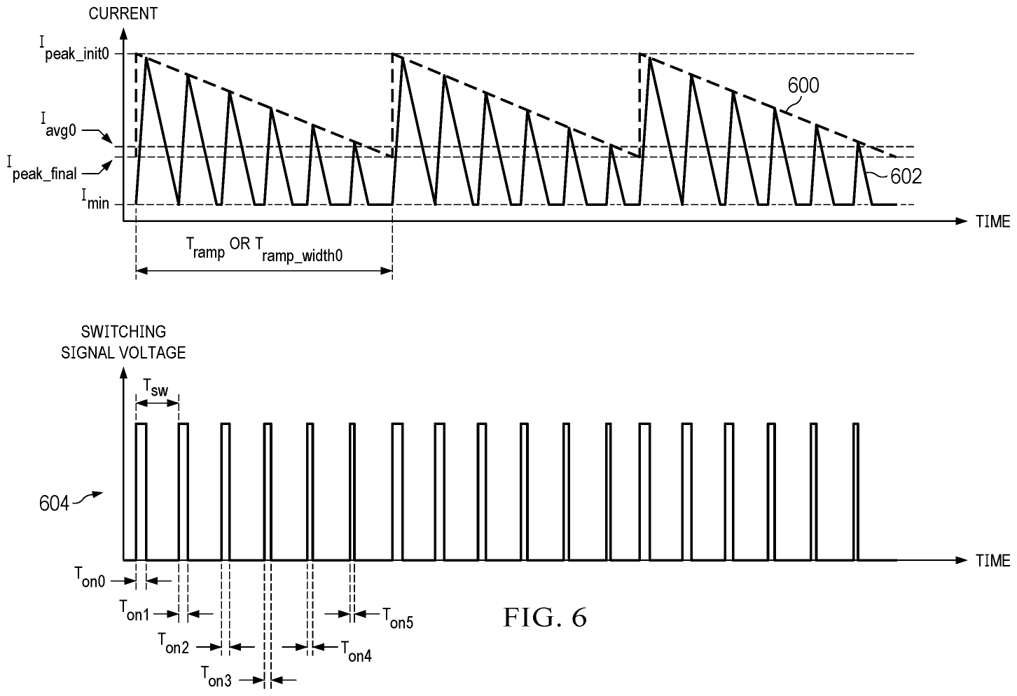

FIG. 6, FIG. 7, and FIG. 8 are graphs that illustrate example techniques of operating SMPS 100 in different light load condition that can address at least some of the issues described above. The load condition in FIG. 6 can be heavier than in FIG. 7 (e.g., with a larger current demand for load 110), and the load condition in FIG. 7 can be heavier than in FIG. 8.

Referring to FIGS. 6-8, a controller can provide a ramp signal to modulate the peak inductor current. Examples of the ramp signal are illustrated in graph 600 of FIG. 6, graph 700 of FIG. 7, and graph 800 of FIG. 8. The ramp signal can have a constant cycle period Tᵣₐₘₚ, which is a multiple of the switching cycle period T_{sw}. In some examples, the switching frequency can be at 2.4 megahertz (MHz), and the frequency of the ramp signal can be at 400 kilohertz (kHz), so that each ramp cycle period can include up to six switching cycles.

Within each ramp cycle period, the magnitude of the ramp signal can reduce with time. The magnitude of the ramp signal can define a peak inductor current target for a particular switching cycle. Both the initial value of the ramp signal at the beginning of a ramp cycle period, and the rate at which the ramp signal reduces with time (the ramp/slew rate), can depend on the load condition. For example, the initial peak inductor current target at the beginning of a ramp cycle period can be I_{peak_init0} in FIG. 6, I_{peak_init1} in FIG. 7, and I_{peak_init2} in FIG. 8, with I_{peak_init0} higher than I_{peak_init1}, and I_{peak_init1} higher than I_{peak_init2}. Also, the ramp rate of the ramp signal has an inverse relationship with the load condition, with a lower ramp rate for a heavier load condition and a higher ramp rate for a lighter load condition. Depending on the ramp rate, the ramp signal can reduce from the initial value at the beginning to a final value at the end of the cycle period, such as i_{peak_final} in FIG. 6, or can reduce to the minimum current value Iₘᵢₙ (e.g., zero) at or before the cycle period as shown in FIGS. 7 and 8.

Graphs 602, 702, and 802 of FIGS. 6-8 illustrate example effects of the ramp signal on the inductor current, and graphs 604, 704, and 804 of FIGS. 6-8 illustrate example effects of the ramp signal on switching signal 114. As described above, the magnitude of the ramp signal can define a peak inductor current target for a particular switching cycle. Responsive to the inductor current reaching the peak inductor current target for that switching cycle, the controller can stop the on-time of the switching cycle and the charging of the inductor, and start the off-time of the switching cycle and discharging of the inductor. Accordingly, the on-time of the switching cycles (e.g., Tₒₙ₀-Tₒₙ₅ in FIG. 6 and Tₒₙ₀-Tₒₙ₃ in FIG. 7) reduces progressively with time within a ramp cycle period.

The controller can adjust the slope (ramp rate) of the ramp signal to adjust the average output current supplied to load 110 and capacitor 108. The average output currents in FIGS. 6-8 are labelled I_{avg0}, I_{avg1}, and I_{avg2} respectively, with I_{avg0} higher than I_{avg1}, and I_{avg1} higher than I_{avg2}. Also, the slope of the ramp signal becomes progressively steeper from FIG. 6 to FIG. 7, and from FIG. 7 to FIG. 8. Specifically, referring to graphs 602, 702, and 802, because the magnitude of the ramp signal defines the peak inductor current target for a particular switching cycle, with a ramp signal having a relatively shallower slope, the peak inductor current target can reduce more slowly within a ramp cycle period. This can increase the total amount of current supplied to the inductor during the charging state, which can also increase the average current supplied by SMPS 100 to the load.

The slope of the ramp also sets the width of the ramp signal T_{ramp_width}, which can represent the duration of time when the peak inductor current target is above Iₘᵢₙ. The ramp signal width can set the number of switching cycles in a ramp period. Specifically, in some examples, the controller may disable the switching of power stage 102 if peak inductor current target is close to or below Iₘᵢₙ, which can indicate that the output current to be supplied by SMPS 100 is below a minimum load condition. Therefore, with a ramp signal having a steeper slope and a narrower width, the number of switching cycles within a ramp cycle period may be reduced, which can further reduce the average current supplied by SMPS 100 to the load. For example, in FIG. 6 the ramp width T_{ramp_width0} is the same as the ramp cycle period Tᵣₐₘₚ, and there are six switching cycles in each ramp cycle. But in FIG. 7 due to the steeper ramp signal, the ramp width T_{ramp_width1} is shorter than T_{ramp_width0}, and the number of switching cycles in each ramp cycle is reduced to four. Further, in FIG. 8, the ramp signal has a steeper slope than in FIG. 7, the ramp width T_{ramp_width2} is shorter than T_{ramp_width1}, and each ramp cycle only includes a single switching cycle. In the example of FIG. 8, the slope of the ramp signal may allow a single switching cycle with a minimum on-time T_{on_min}. Due to delay in turning off switch 112a and turning on switch 112b, the inductor current may become negative due to ringing, which can further reduce the average current supplied by SMPS 100 to the load.

The example control techniques described in FIGS. 6-8 can improve the conformance of SMPS 100 to EMI requirements while operating in the light load condition. Specifically, both the frequency of the ramp signal, and the switching frequency, can be selected to conform to the EMI requirements, and both frequencies can be constant or invariable with respect to the load condition. Accordingly, the switching signal can have fundamental and harmonic frequency components that satisfy the EMI requirements irrespective of the load condition. Compared with the PFM operation described in FIGS. 4 and 5 where the switching signal frequency is variable with the load and may violate the EMI requirement at a particular load condition, the example control techniques described in FIGS. 6-8 allow for more predictable conformance to the EMI requirements.

Also, compared with the FPWM operations described in FIG. 5, the control techniques described in FIGS. 6-8 can improve the efficiency of SMPS 100 while conforming to the EMI requirements. As described above, while the switching frequency in an FPWM operation can be selected to conform to the EMI requirements, the off-time of each switching cycle is extended to allow the inductor current to reach a negative minimum value to reduce the average output current. However, the conduction of negative current in each switching cycle, which consumes significant amount of power, can significantly degrade the efficiency of SMPS 100. In contrast, in the example control techniques described in FIGS. 6-8, the ramp signal can modulate the peak inductor current, and the average output current can be reduced by increasing the slope of the ramp signal. The conduction of negative inductor current can be reduced, and the efficiency of SMPS 100 while operating in the light load condition can be improved.

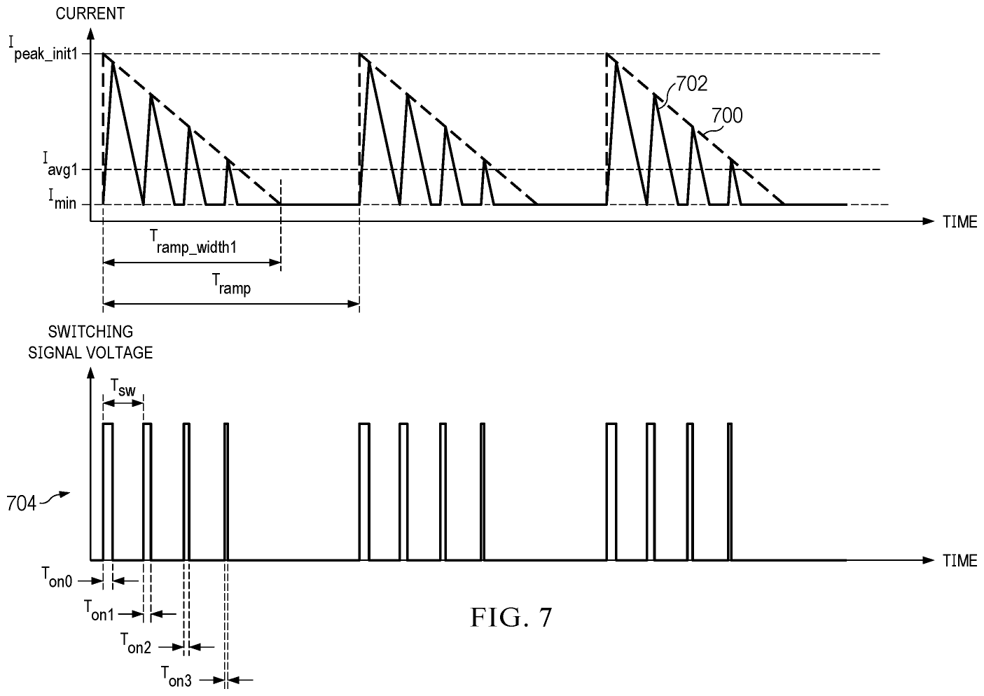

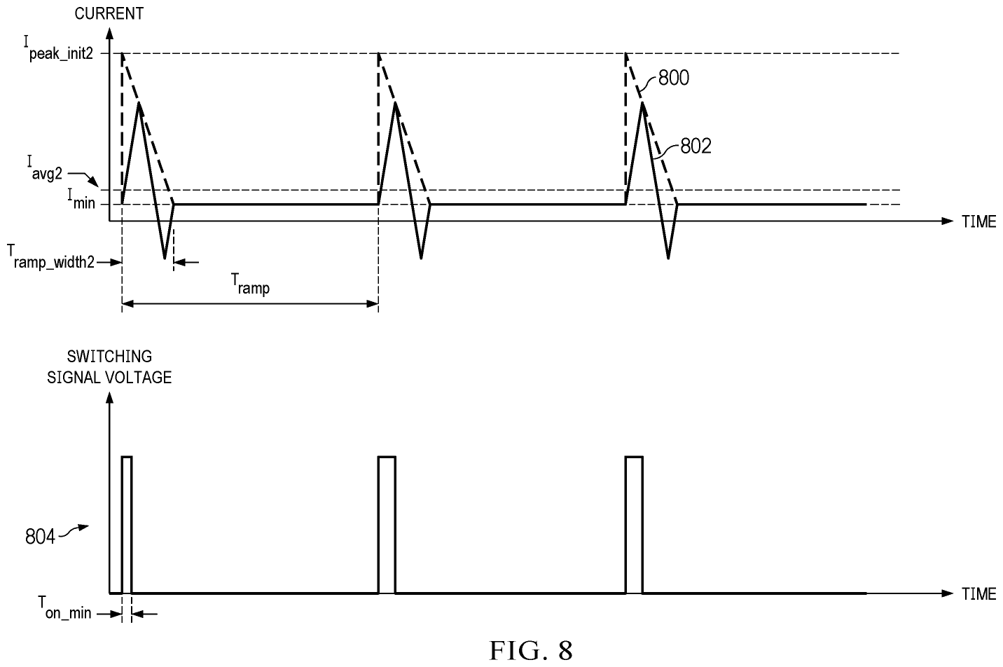

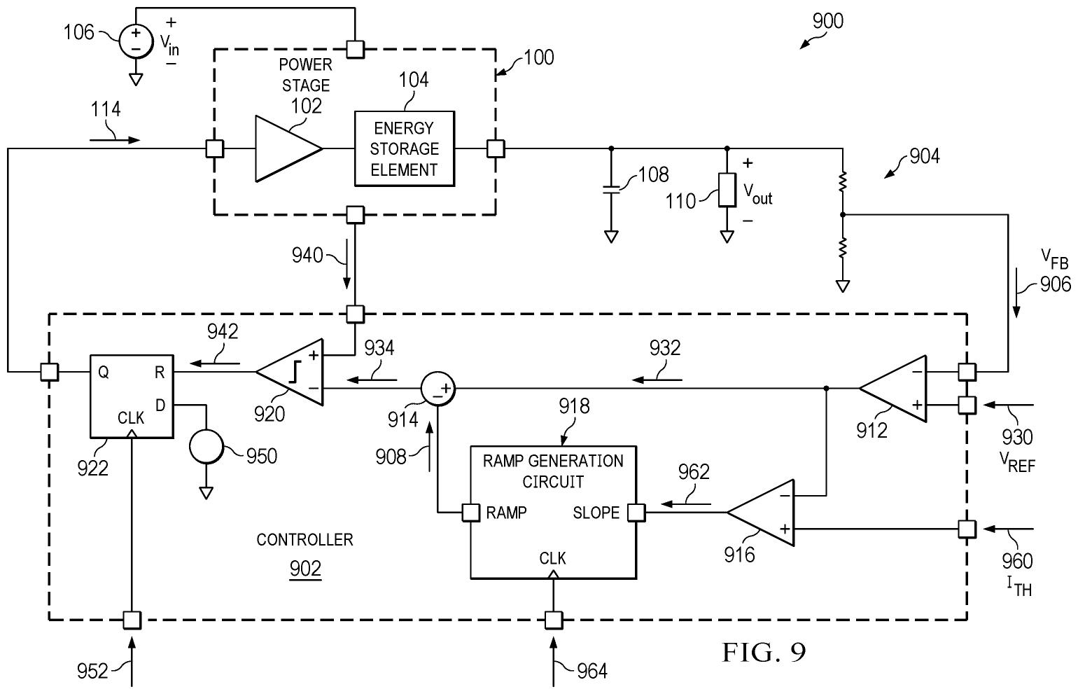

FIG. 9 is a schematic of an example power supply system 900 that can implement the example control techniques of FIGS. 6-8. Referring to FIG. 9, power supply system 900 includes SMPS 100 and a controller 902. Power supply system 900 also includes a voltage divider 904 (e.g., a resistive divider) to provide a feedback voltage (V_{FB}) 906 representing the output voltage (Vₒᵤₜ) of SMPS 100. Controller 902 can determine the load condition based on V_{FB} 906, and operate SMPS 100 in different operation modes depending on the load condition. In a non-light load condition, controller 902 can operate SMPS 100 in the PWM mode similar to the operations described in FIG. 2. In a light load condition, controller 902 can operate SMPS 100 by providing a ramp signal 908 to modulate the peak inductor current, as described in FIGS. 6-8.

Specifically, controller 902 can include amplifiers 912, 914, and 916, a ramp generation circuit 918, a comparator 920, and a switching signal generation circuit 922. Amplifier 912 has a first input (e.g., a negative input) coupled to voltage divider 904 to receive V_{FB} 906. Amplifier 912 also has a second input (e.g., a positive input) to receive a reference voltage signal (V_{REF}) 930, which can represent a target output voltage of SMPS 100. Amplifier 912 can generate an error signal 932 representing a voltage difference between V_{FB} 906 and V_{REF} 930. The magnitude (e.g., voltage) of error signal 932 can indicate the load condition. This is because if SMPS 100 is not providing sufficient current to load 110, capacitor 108 can discharge to supply additional current, which causes the output voltage (and V_{FB} 906) to drop, and the voltage difference increases. Accordingly, an error signal 932 having a large magnitude (e.g., a large voltage) can indicate a larger target current to be supplied by SMPS 100, which can represent a heavy load condition. Also, an error signal 932 having a small magnitude (e.g., a small voltage) can indicate a smaller target current to be supplied by SMPS 100, which can represent a light load condition.

In some examples, controller 902 can include a clamp circuit 933 coupled to the output of amplifier 912 to set an upper limit and a lower limit of the magnitude of error signal 932. Clamp circuit 933 can include unity-gain voltage buffers. The upper limit of error signal 932 can represent a peak inductor current limit for SMPS 100 in a heavy load condition. Also, the lower limit of error signal 932 can represent a threshold for light load condition. Under the light load condition, the magnitude of error signal 932 can be at the lower limit, and controller 902 can modulate the peak inductor current by a combination of error signal 932 and ramp signal 908 as to be described below.

Amplifier 914 has a first input coupled to the output of amplifier 912 to receive error signal 932. Amplifier 914 also has a second input coupled to a ramp signal terminal of ramp generation circuit 918 to receive ramp signal 908. Amplifier 914, which can include a subtraction circuit, can generate a current target signal 934 by subtracting ramp signal 908 from error signal 932. As to be discussed below, during a non-light load condition, ramp generation circuit 918 can generate a flat/static ramp signal 908 (e.g., at 0 v or a ground voltage), and current target signal 934 can represent error signal 932. Also, during a light load condition, ramp generation circuit 918 can generate ramp signal 908 having a ramp rate/slew rate that reflects the load condition, and current target signal 934 can also include a ramp signal similar to those illustrated by graphs 600, 700, and 800 of FIGS. 6-8. The magnitude (e.g., voltage) of current target signal 934 can define a peak current conducted by energy storage element 104 (e.g., peak inductor current) in a switching cycle.

Comparator 920 can have a first input (e.g., a positive input) coupled to a current sense terminal of SMPS 100 and a second input (e.g., a negative input) coupled to the output of amplifier 914. Comparator 920 can receive a current sense signal 940 representing a measurement of the inductor current in SMPS 100 at the first input, and current target signal 934 at the second input, and generate a decision signal 942 representing a comparison between the inductor current and a peak inductor current target represented by current target signal 934. Comparator 920 can generate decision signal 942 having a first state (e.g., a logical zero) if the inductor current is below the peak inductor current target, and switch decision signal 942 to a second state (e.g., a logical one) if the inductor current equals the peak inductor current target. In some examples, if current target signal 934 is below a threshold (e.g., an input voltage range of comparator 920) representing a minimum load condition, comparator 920 can maintain decision signal 942 in the second state.

Switching signal generator 922, which can include a clocked sequential logic circuit such as a flip-flop, has a first signal input coupled to the output of comparator 920 to receive decision signal 942. Switching signal generator 922 also has a second signal input coupled to a voltage source 950, and a clock input to receive a first clock signal 952. Switching signal generator 922 also has a signal output coupled to a control terminal of power stage 102 (e.g., control terminals of switches 112a and 112b) to provide switching signal 114. In some examples, the first signal input can be coupled to the reset input (labelled R) of the flip flop, the second signal input can be coupled to the data input (labelled D) of the flip flop, and the signal output can be coupled to the data output (labelled Q) of the flip flop. Voltage source 950 can provide a voltage representing a logical one.

First clock signal 952 can define the switching frequency of switching signal 114. For example, in a case where the switching frequency is at 2.4 MHz, first clock signal 952 can have a frequency of 2.4 MHz. Each switching cycle starts with decision signal 942 (and the reset input) having a logical zero state. The on-time (Tₒₙ) of a switching cycle starts. Switching signal 114 can have a first state that enables power stage 102, and the inductor current increases with time as the inductor is in a charging state. As the inductor current increases and becomes equal to the peak current target, decision signal 942 (and the reset input) can switch to the logical one state. Responsive to the switching of decision signal 942, switching signal 114 can also switch to a second state that disables power stage 102, and the on-time of the switching cycle ends. The inductor current then reduces with time as the inductor discharges. Also, in a case where minimum load condition is reached, decision signal 942 (and the reset input) can stay in the logical one state, which keeps the flip-flop in the reset state and power stage 102 in the disabled state.

Also, in the light load condition, amplifier 916 and ramp generation circuit 918 can generate a ramp signal 908 having a ramp rate/slew rate that reflects the load condition. Specifically, amplifier 916 has a first input (e.g., a negative input) coupled to the output of amplifier 912 to receive error signal 932. Amplifier 916 has a second input (e.g., a positive input) to receive a current threshold (I_{TH}) signal 960. Current threshold signal 960 can be a voltage signal representing the threshold for light load condition. Amplifier 916 can generate a slope signal 962 representing a difference between the error signal 932 and current threshold signal 960. In some examples, error signal 932 and current threshold signal 960 are voltage signals, and the difference is a voltage difference. If error signal 932 exceeds current threshold signal 960, amplifier 916 can generate slope signal 962 having a disabled/inactive state (e.g., having a voltage/current below a threshold). But if error signal 932 is below current threshold signal 960, which indicates that the load current to be supplied by SMPS 100 is below the threshold for the light load condition, amplifier 916 can generate slope signal 962 in an enabled/active state (e.g., having a voltage/current above the threshold), and the magnitude of slope signal 962 can represent a difference between error signal 932 and current threshold signal 960. The difference can represent the amount of current (e.g., average current) to be supplied by SMPS 100 to load 110 under the light load condition.

Ramp generation circuit 918 includes a slope control terminal, a ramp signal terminal, and a clock input. The slope control terminal of ramp generation circuit 918 is coupled to the output of amplifier 916, and the ramp signal terminal of ramp generation circuit 918 is coupled to the second input of amplifier 914. Ramp generation circuit 918 can receive slope signal 962 via the slope control terminal. Responsive to slope signal 962 having the disabled/inactive state, ramp generation circuit 918 can be disabled. Also, responsive to slope signal 962 having an enabled/active state, ramp generation circuit 918 can provide ramp signal 908 having the ramp/slew rate based on the magnitude of slope signal 962.

Ramp generation circuit 918 also has a clock input to receive a second clock signal 964 which defines the cycle period of ramp signal 908. For example, second clock signal 964 can have a frequency of at 400 kHz. In each ramp cycle period, ramp generation circuit 918 can provide ramp signal 908 having the ramp/slew rate based on slope signal 962.

In some examples, ramp generation circuit 918 can generate ramp signal 908 that increases with time in each ramp cycle period. Accordingly, current threshold signal 960, which is from the subtraction between error signal 932 and ramp signal 908, can ramp down and provide a reducing peak inductor current target similar to those represented by graphs 600, 700, and 800 of FIGS. 6-8. Ramp generation circuit 918 can also set the ramp rate of ramp signal 908 according to an inverse relationship with slope signal 962, which represents the load condition. For example, ramp generation circuit 918 can decrease the ramp rate of ramp signal 908 responsive to an increase in the magnitude of slope signal 962. With the ramp rate of ramp signal 908 reduced, the rate of reduction of the peak inductor current across switching cycles within a ramp cycle period can be reduced, and the average output current can be increased to satisfy a relatively heavy load condition. Also, ramp generation circuit 918 can increase the ramp rate of ramp signal 908 responsive to a decrease in the magnitude of slope signal 962. With the rate of reduction of the peak inductor current across switching cycles within a ramp cycle period increased, the average output current can be decreased to satisfy a relatively light load condition.

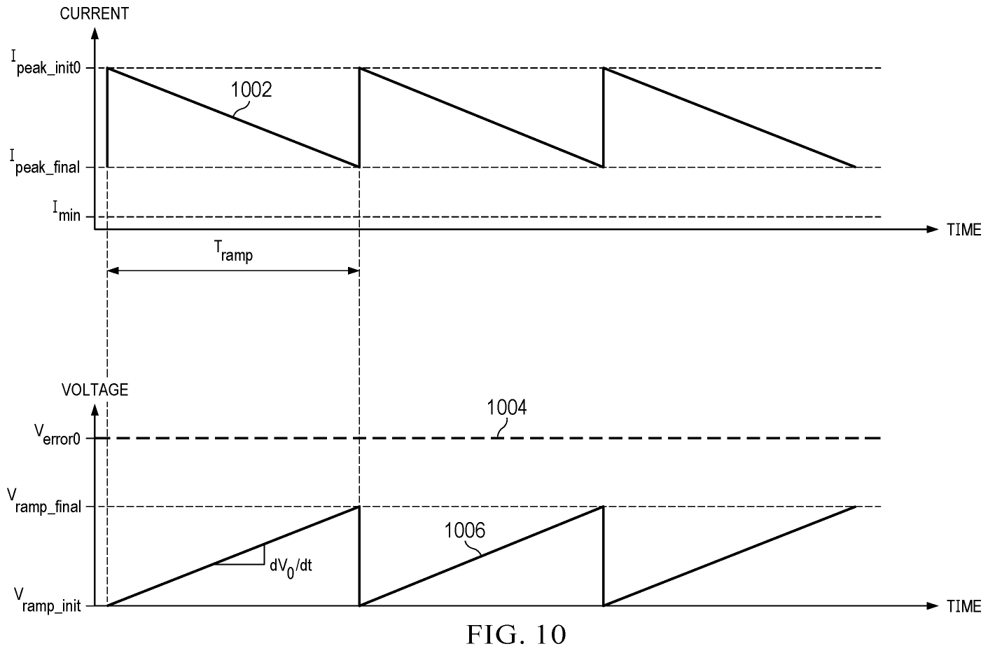

FIGS. 10, 11, and 12 are graphs that illustrate examples of ramp signal 908, current target signal 934, and error signal 932 under various light load conditions. The operations of controller 902 and SMPS 100 illustrated in FIG. 10 are to provide a larger load current than in FIG. 11, which illustrates operations to provide a larger load current than in FIG. 12. In FIGS. 10-12, ramp signal 908 and error signal 932 are represented as voltage signals.

FIG. 10 illustrates graphs 1002, 1004, and 1006. Graph 1002 represents the variation of a peak inductor current target represented by current target signal 934 with time, graph 1004 represents the variation of error signal 932 with time, and graph 1006 represents the variation of ramp signal 908 with time. Graphs 1002-1006 illustrate example operations of controller 902 and SMPS 100 under the same load condition as in FIG. 7, and graph 1002 can be identical to graph 700 of FIG. 7.

Referring to graphs 1004 and 1006, within each ramp cycle period Tᵣₐₘₚ, ramp generation circuit 918 can provide ramp signal 908 that increases with time at a slew rate dV₀/dt based on slope signal 962. With a rate of dV₀/dt, ramp signal 908 can increase from an initial ramp voltage V_{ramp_init0} to a final ramp voltage Vᵣₐₘₚ final within a ramp cycle period. In some examples, the initial ramp voltage V_{ramp_init0} can be 0 v (or a ground voltage). The final ramp voltage Vᵣₐₘₚ final is lower than the voltage of error signal 932, which has a voltage Vₑᵣᵣₒᵣ₀ representing the same load condition represented by slope signal 962 (and slew rate dV₀/dt).

Also, referring to graph 1002, amplifier 914 (or a subtraction circuit) can generate current target signal 934 by subtracting ramp signal 908 from error signal 932. Accordingly, the peak inductor current target represented current target signal 934 can be at the highest at the beginning of the ramp cycle period and has the value of I_{peak_init0}. The peak inductor current target reduces with time within the ramp cycle period as ramp signal 908 increases. The peak inductor current target can have the value of I_{peak_final} at the end of the ramp cycle period.

FIG. 11 illustrates graphs 1102, 1104, and 1106. Graph 1102 represents the variation of a peak inductor current target represented by current target signal 934 with time, graph 1104 represents the variation of error signal 932 with time, and graph 1106 represents the variation of ramp signal 908 with time. Graphs 1102-1106 illustrate example operations of controller 902 and SMPS 100 under the same load condition as in FIG. 8, and graph 1102 can be identical to graph 800 of FIG. 8.

Referring to graphs 1104 and 1106, within each ramp cycle period Tᵣₐₘₚ, ramp generation circuit 918 can provide ramp signal 908 that increases with time at a slew rate dV₁/dt based on slope signal 962. With a rate of dV₁/dt, ramp signal 908 can increase from an initial ramp voltage V_{ramp_init} (which can be 0 v) and reach the voltage of error signal 932, Vₑᵣᵣₒᵣ₁, before the ramp cycle period ends. The duration for ramp signal 908 to increase from V_{ramp_init} to Vₑᵣᵣₒᵣ₁ can define the ramp width T_{ramp_width1} of current target signal 934. Ramp signal 908 can be at Vₑᵣᵣₒᵣ₁ for the remainder of the ramp cycle period, and then switch to V_{ramp_init} at the beginning of the next ramp cycle. The voltage Vₑᵣᵣₒᵣ₁ represents the same load condition represented by slope signal 962 (and slew rate dV₁/dt). As described above, FIG. 11 represents a lighter load condition than in FIG. 10. Accordingly, Vₑᵣᵣₒᵣ₁ is lower than Vₑᵣᵣₒᵣ₀ of FIG. 10, and the slew rate dV₁/dt is higher than the slew rate dV₀/dt of FIG. 10.

Also, referring to graph 1002, amplifier 914 (or a subtraction circuit) can generate current target signal 934 by subtracting ramp signal 908 from error signal 932. Accordingly, the peak inductor current target represented by current target signal 934 can be at the highest at the beginning of the ramp cycle period and has the value of I_{peak_init1}. The peak inductor current target reduces with time within the ramp cycle period as ramp signal 908 increases. The peak inductor current target can reach the minimum current value Iₘᵢₙ after a duration of T_{ramp_width1} has elapsed has elapsed from the start of the ramp cycle period, when ramp signal 908 has the same voltage as error signal 932 (Vₑᵣᵣₒᵣ₁). The peak inductor current target can remain at Iₘᵢₙ for the remainder of the ramp cycle period.

FIG. 12 illustrates graphs 1202, 1204, and 1206. Graph 1202 represents the variation of a peak inductor current target represented by current target signal 934 with time, graph 1204 represents the variation of error signal 932 with time, and graph 1206 represents the variation of ramp signal 908 with time. Graphs 1202-1206 illustrate example operations of controller 902 and SMPS 100 under the same load condition as in FIG. 8, and graph 1202 can be identical to graph 800 of FIG. 8.

Referring to graphs 1204 and 1206, within each ramp cycle period Tᵣₐₘₚ, ramp generation circuit 918 can provide ramp signal 908 that increases with time at a slew rate dV₂/dt based on slope signal 962. With a rate of dV₂/dt, ramp signal 908 can increase from an initial ramp voltage V_{ramp_init} (which can be 0 v) and reach the voltage of error signal 932, Vₑᵣᵣₒᵣ₂, before the ramp cycle period ends. The duration for ramp signal 908 to increase from V_{ramp_init} to Vₑᵣᵣₒᵣ₂ can define the ramp width T_{ramp_width2} of current target signal 934. Ramp signal 908 can stay at Vₑᵣᵣₒᵣ₂ for the remainder of the ramp cycle period, and then switch to V_{ramp_init} at the beginning of the next ramp cycle. The voltage Vₑᵣᵣₒᵣ₂ represents the same load condition represented by slope signal 962 (and slew rate dV₂/dt). As described above, FIG. 12 represents a lighter load condition than in FIG. 11. Accordingly, Vₑᵣᵣₒᵣ₂ is lower than Vₑᵣᵣₒᵣ₁ of FIG. 11 (and Vₑᵣᵣₒᵣ₀ of FIG. 10), and the slew rate dV₂/dt is higher than the slew rate dV₁/dt of FIG. 11 (and the slew rate dV₀/dt of FIG. 10). Also, because of the higher slew rate and reduced Vₑᵣᵣₒᵣ₂, ramp signal 908 can increase from V_{ramp_init} to Vₑᵣᵣₒᵣ₂ within a shorter duration than to Vₑᵣᵣₒᵣ₁, and ramp width T_{ramp_width2} of FIG. 12 is shorter than ramp width T_{ramp_width1} of FIG. 11.

Also, referring to graph 1202, amplifier 914 (or a subtraction circuit) can generate current target signal 934 by subtracting ramp signal 908 from error signal 932. Accordingly, the peak inductor current target represented by current target signal 934 can be at the highest at the beginning of the ramp cycle period and has the value of I_{peak_init2}. The peak inductor current target reduces with time within the ramp cycle period as ramp signal 908 increases with time. The peak inductor current target can reach the minimum current value Iₘᵢₙ after a duration of T_{ramp_width2} has elapsed from the start of the ramp cycle period, when ramp signal 908 has the same voltage as error signal 932 (Vₑᵣᵣₒᵣ₂). The peak inductor current target can remain at Iₘᵢₙ for the remainder of the ramp cycle period.

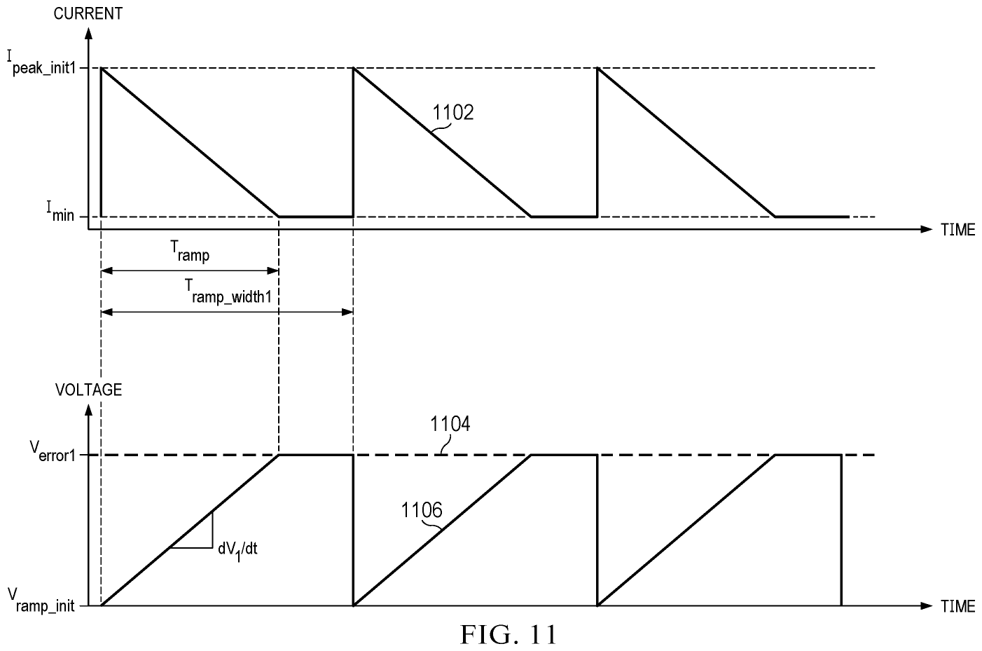

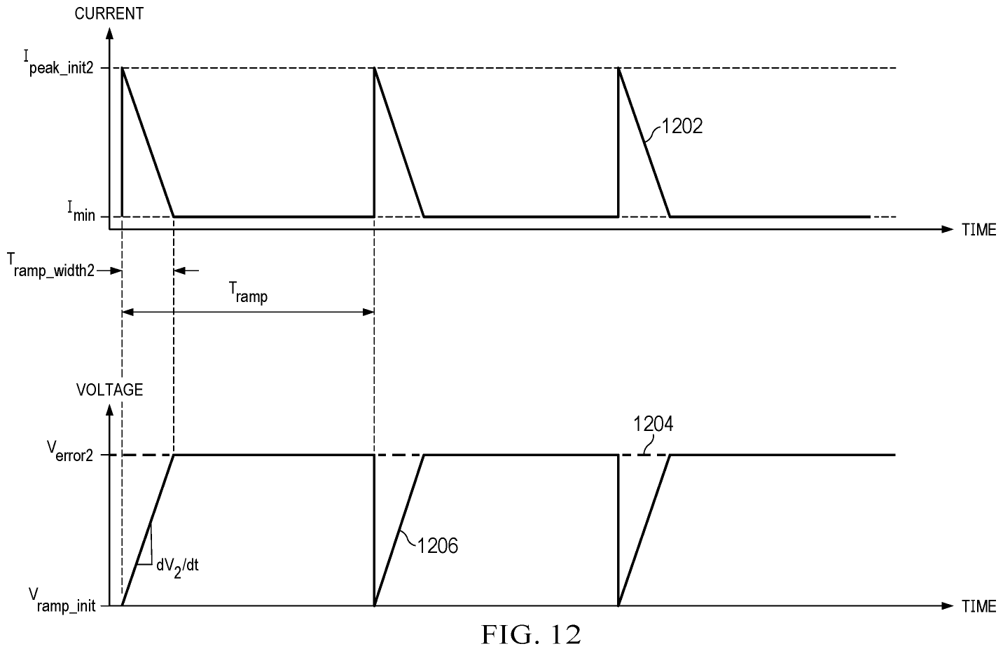

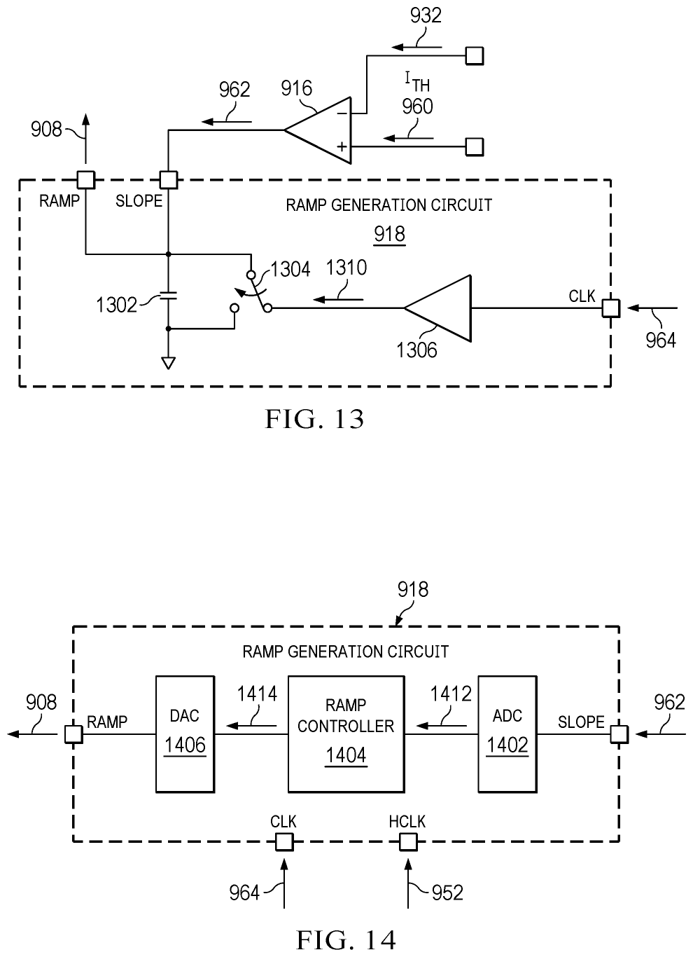

FIG. 13 is a schematic that illustrates examples of internal components of ramp generation circuit 918. Referring to FIG. 13, in some examples, ramp generation circuit 918 includes a capacitor 1302 and switch 1304. A top plate of capacitor 1302 is coupled both the slope control terminal and the ramp signal terminal, and a bottom plate of capacitor 1302 is coupled to a ground terminal. Switch 1304 is also coupled between the slope control terminal (and the ramp signal terminal) and the ground terminal. Ramp generation circuit 918 also includes a switch driver circuit 1306 coupled between the clock input and a control terminal of switch 1304. Switch driver circuit 1306 can provide a control signal 1310 to turn on/off switch 1304 responsive to second clock signal 964.

Specifically, at the beginning of each ramp cycle period, switch driver circuit 1306 can provide control signal 1310 having a first state for a short duration to turn on switch 1304, which shorts the top and bottom plates of capacitor 1302 to remove the stored charge, and the slope control terminal and the ramp signal terminal can have the V_{ramp_init} voltage (e.g., 0 v) of the ground terminal. Switch driver circuit 1306 can then switch control signal 1310 to a second state for the remainder of the ramp cycle period to turn off switch 1304, and the slope control terminal and the ramp signal terminal can be disconnected from the ground terminal.

With switch 1304 turned off, amplifier 916 can provide slope signal 962 to charge the capacitor 1302. In some examples, amplifier 916 can include a transconductance amplifier and can provide slope signal 962 as a current signal, with the magnitude of the current signal representing a voltage difference between error signal 932 and current threshold signal 960. As described above, the voltage of error signal 932 increases with the amount of current to be supplied by SMPS 100. Accordingly, under a light load condition (e.g., as illustrated in FIGS. 10 and 11), the voltage of error signal 932 can be close to the light load condition threshold represented by current threshold signal 960. Accordingly, the voltage difference between error signal 932 and current threshold signal 960 can be relatively small. The small voltage difference causes amplifier 916 to provide a reduced current in slope signal 962 to charge capacitor 1302. Because capacitor 1302 is charged with a reduced current, the voltage of ramp signal 908 at the ramp signal terminal can increase with time more slowly, which lead to a relatively low slew/ramp rate as shown in FIGS. 10 and 11.

Also, under a very light load condition (e.g., as illustrated in FIG. 12), the voltage of error signal 932 can be relatively small and is significantly different from the light load condition threshold represented by current threshold signal 960. Accordingly, the voltage difference between error signal 932 and current threshold signal 960 can be relatively large. The increased voltage difference causes amplifier 916 to provide an increased current in slope signal 962 to charge capacitor 1302. Because capacitor 1302 is charged with an increased current, the voltage of ramp signal 908 at the ramp signal terminal can increase with time more quickly, which lead to a relatively high slew/ramp rate as shown in FIG. 12. In some examples, amplifier 916 can clamp the voltage of the top plate of capacitor 1302 (and the voltage of the ramp/slope control terminal) at the voltage of error signal 932 (e.g., Vₑᵣᵣₒᵣ₁ and Vₑᵣᵣₒᵣ₂ of FIGS. 11 and 12), so that the ramp voltage stops rising after reaching the voltage of error signal 932.

FIG. 14 is a schematic that illustrates examples of internal components of ramp generation circuit 918. Referring to FIG. 14, in some examples, ramp generation circuit 918 includes an analog-to-digital converter (ADC) 1402, a ramp controller 1404, and a digital-to-analog converter (DAC) 1406. ADC 1402 can have an analog input coupled to the slope control terminal and a digital output coupled to an input of ramp controller 1404. An output of ramp controller 1404 can be coupled to a digital input of DAC 1406, and an analog output of DAC 1406 is coupled to the ramp signal terminal. Also, ADC 1402 is coupled to the clock input (CLK), and ramp controller 1404 are also coupled to the CLK input and a high speed clock input (HCLK). HCLK input can receive first clock signal 952 having the switching frequency, and CLK input can receive second clock signal 964 having the ramp signal frequency.

Specifically, ADC 1402 can sample slope signal 962 at the ramp signal frequency, and provide a digital signal 1412 of slope signal 962 to ramp controller 1404. Based on digital signal 1412, ramp controller 1404 can provide control signal 1414 to DAC 1406 to generate ramp signal 908. Ramp controller 1404 can determine whether the light load threshold is reached based on slope signal 962. If digital signal 1412 represents that light load threshold is not reached (e.g., digital signal 1412 representing a zero), ramp controller 1404 can provide control signal 1414 to DAC 1406 to provide a voltage signal at V_{ramp_init} (which can be 0 v).

Also, if digital signal 1412 represents that light load threshold is reached (e.g., digital signal 1412 being non-zero), ramp controller 1404 can determine the voltage range and the slope of ramp signal 908 based on digital signal 1412. As described above, under a light load condition, the magnitude of slope signal 962 can be relatively large (due to increased difference between error signal 932 and current threshold signal 960), digital signal 1412 can represent a large digital value, and ramp controller 1404 can set a high slew rate for ramp signal 608. Also, under a very light load condition, the magnitude of slope signal 962 can be relatively small (due to reduced difference between error signal 932 and current threshold signal 960), digital signal 1412 can represent a small digital value, and ramp controller 1404 can set a low slew rate of ramp signal 608. Ramp controller 1404 can also determine an instantaneous voltage of ramp signal 908 at a switching cycle based on the slew rate and clamp the voltage to at error signal 932. Within each ramp signal cycle, ramp controller 1404 can provide control signal 1414 representing the instantaneous voltage, and update control signal 1414 at each switching cycle, so that DAC 1406 can provide ramp signal 608 that increases with time at a ramp/slew rate that represents the load condition, as illustrated in graphs 1006, 1106, and 1206 of FIGS. 10-12.

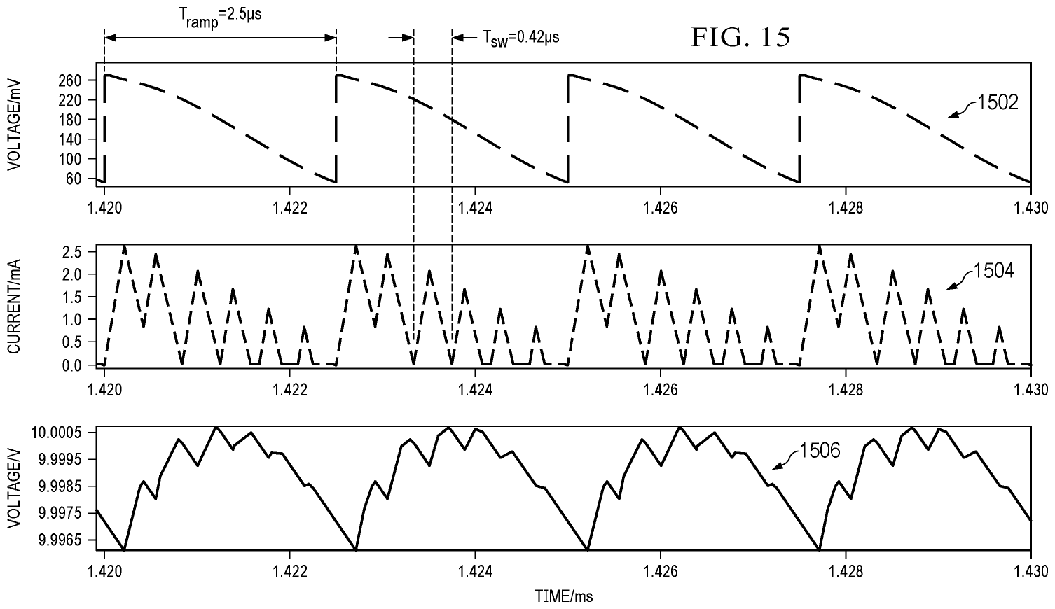

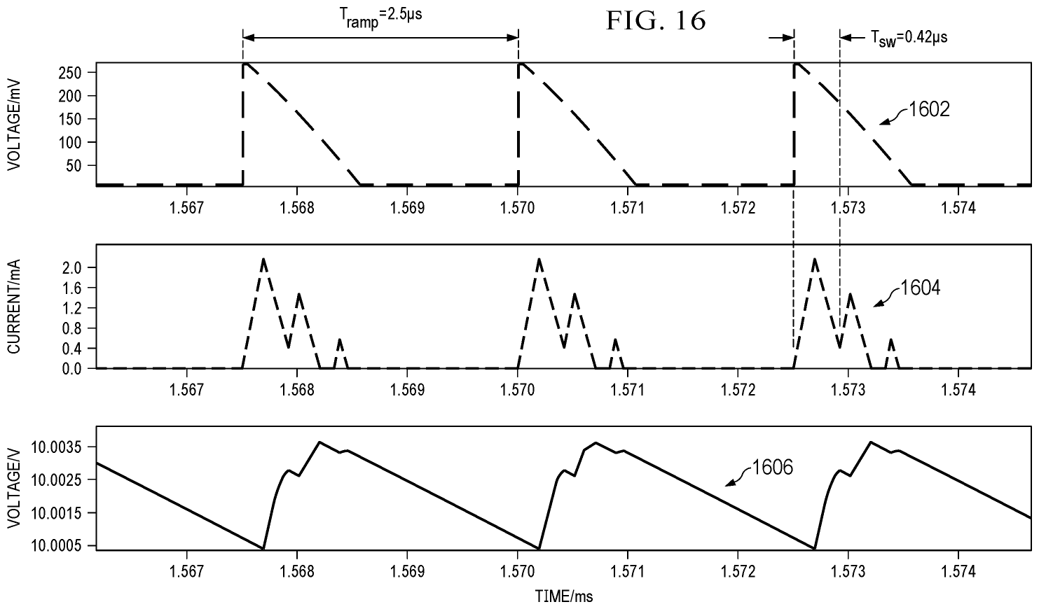

FIGS. 15, 16, and 17 are graphs that illustrate additional examples of current target signal 934, inductor current, and output voltage of an SMPS (e.g., SMPS 100) across multiple ramp cycle periods Tᵣₐₘₚ under different load conditions. FIG. 15 includes graphs 1502, 1504, and 1506 illustrating example operations of controller 902 and SMPS 100 in providing an average current of 500 mA. FIG. 16 includes graphs 1602, 1604, and 1606 illustrating example operations of controller 902 and SMPS 100 in providing an average current of 200 mA. FIG. 17 includes graphs 1702, 1704, and 1706 illustrating example operations of controller 902 and SMPS 100 in providing an average current of 50 mA. In FIGS. 15-17, the ramp cycle period Tᵣₐₘₚ equals 2.5 microsecond (us) for a ramp signal frequency of 400 kHz, and the switching cycle period T_{sw} equals 0.4167 us for a switching frequency of 2.4 MHz.

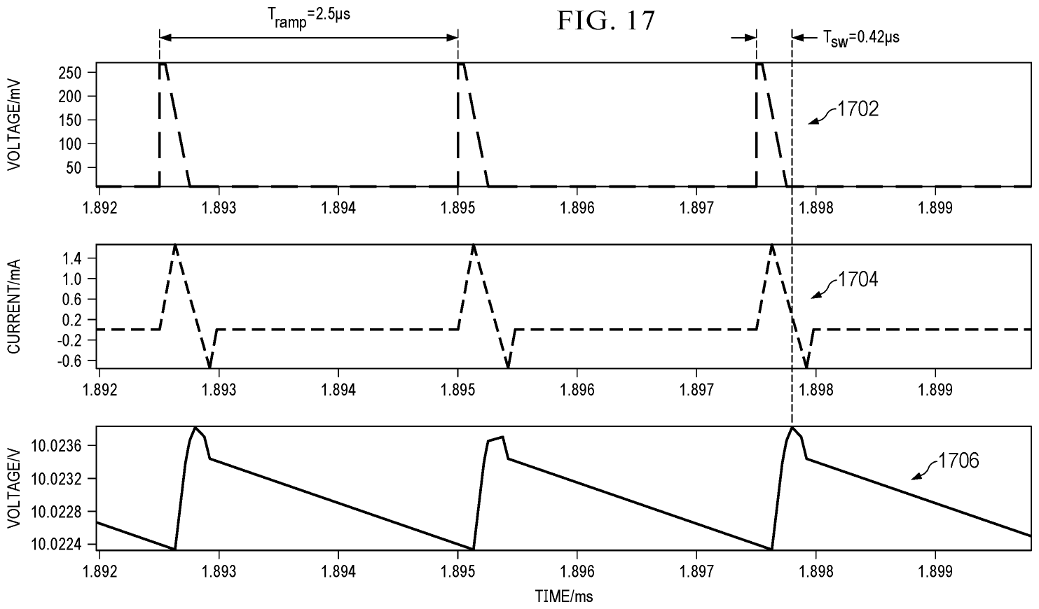

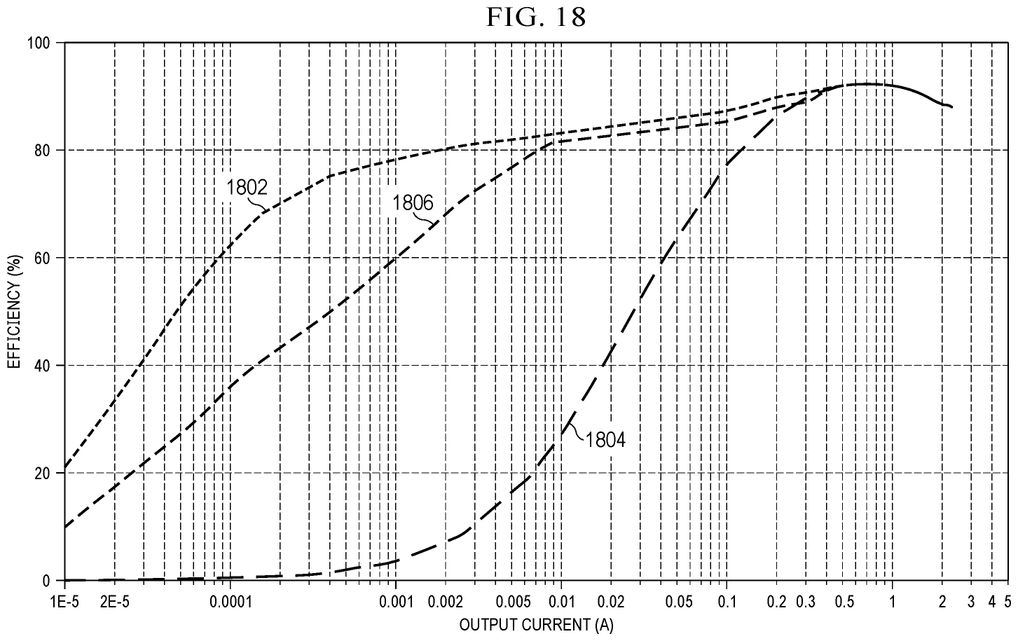

FIG. 18 includes graphs that illustrate example variations of efficiency of an SMPS (e.g., SMPS 100) with respect to load current under different operation modes. The efficiency can be based on a ratio between an amount of power delivered by a power source (e.g., power source 106) to the SMPS, and an amount of power delivered by the SMPS to the load. FIG. 18 includes graphs 1802, 1804, and 1806. Graph 1802 illustrates example variation of efficiency of the SMPS operating under PFM mode similar to FIG. 3. Graph 1804 illustrates example variation of efficiency of the SMPS operating under FPWM mode similar to FIG. 5. Graph 1806 illustrates example variation of efficiency of the SMPS where the peak inductor current is modulated by a ramp signal, as described in FIGS. 6-8 and FIGS. 10-12.

As shown in FIG. 18, by modulating the peak inductor current with a ramp signal according to the load condition, the efficiency of the SMPS can be higher than FPWM mode for a very broad range of load condition (e.g., an output current range of 0.1 uA to 0.2 A). The efficiency improvement is especially substantial in a light load condition (e.g., 0.1 uA to 0.01 mA). This is because in FPWM mode, the SMPS conducts constant negative inductor current in each switching cycle to reduce the average current. In contrast, by modulating the peak inductor current with a ramp signal, the average current can be reduced by increasing the ramp rate, and the conduction of negative inductor current can be reduced or otherwise not needed to reduce the average current. Accordingly, the reduction of negative inductor current can substantially improve the efficiency of the SMPS. The efficiency of SMPS with ramp modulation of peak inductor current is also similar to PFM over a broad range of load condition, such as when load current exceeds 0.01 A.

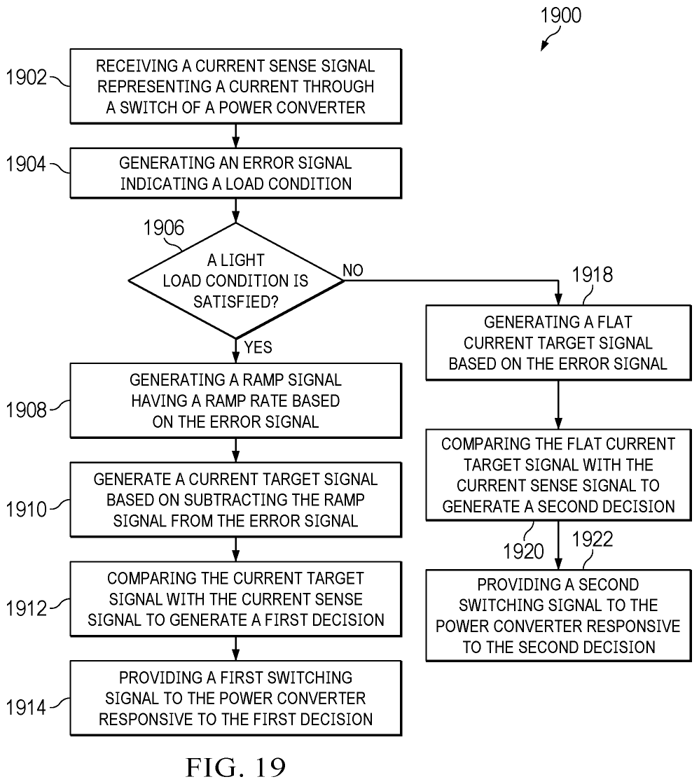

FIG. 19 is a flowchart of an example method 1900 of controlling a power converter, such as SMPS 100. Method 1900 can be performed by a controller, such as controller 402.

In operation 1902, the controller can receive a current sense signal (e.g., current sense 940) representing an inductor current of a power converter. As described above, the inductor current increases during an on-time of a power stage of the power converter (e.g., power stage 102) when the inductor is in a charging state. The inductor current decreases during an off-time of the power stage when the inductor is in a discharging state.

In operation 1904, the controller can generate an error signal indicating a load condition. In some examples, the controller can receive a feedback voltage (e.g., V_{FB} 906) from the power converter and a reference voltage signal (e.g., V_{REF} 930), and generate an error signal (e.g., error signal 932) representing a difference between an output voltage of the power converter and a reference voltage. The error signal can also represent an amount of current to be supplied by the SMPS to the load, and can indicate the load condition. The reference voltage can represent a target output voltage of the power converter, and the magnitude of the error signal can indicate the load condition. As described above, if the SMPS is providing insufficient amount of current to the load, which indicates a heavy load condition, a capacitor at the load (e.g., capacitor 108) can discharge to supply additional current, which causes the output voltage to drop and increases the voltage difference. Accordingly, an error signal having a large magnitude (e.g., a large voltage) can indicate a larger target current to be supplied by the SMPS, which represents a heavy load condition. Also, an error signal having a small magnitude (e.g., a small voltage) can indicate a smaller target current to be supplied by SMPS, which represents a light load condition.

In operation 1906, the controller can determine whether a light load condition is satisfied based on the error signal. Specifically, the controller (e.g., amplifier 916) can generate slope signal 962 representing a difference between the error signal and a current threshold signal (e.g., current threshold signal 960). In some examples, both the error signal and the current threshold signal are voltage signals, and the difference can be a voltage difference. The current threshold signal represents a threshold for a light load condition. Referring to FIG. 9, if error signal 932 exceeds the current threshold signal, which indicates that light load condition is not satisfied, amplifier 916 can generate slope signal 962 having a disabled/inactive state. But if error signal 932 is below current threshold signal 960, which indicates that the load current to be supplied by SMPS 100 is below the threshold for the light load condition and the light load condition is satisfied, amplifier 916 can generate slope signal 962 in an enabled/active state (e.g., having a voltage/current above the threshold), and the magnitude of slope signal 962 can represent a difference between error signal 932 and current threshold signal 960. The difference can represent the amount of current (e.g., average current) to be supplied by SMPS 100 to load 110 under the light load condition.

If the light load condition is satisfied (e.g., error signal 932 is below current threshold signal 960), the controller can proceed to operation 1908 and generate a ramp signal (e.g., ramp signal 908) having a ramp rate based on the error signal. Specifically, the controller (e.g., ramp generation circuit 918) can also set the ramp rate of ramp signal 908 according to an inverse relationship with slope signal 962, which represents the load condition. For example, ramp generation circuit 918 can decrease the ramp rate of ramp signal 908 responsive to an increase in the magnitude of slope signal 962, which can reduce the rate of reduction of the peak inductor current across switching cycles within a ramp cycle period and increase the average output current. Also, ramp generation circuit 918 can increase the ramp rate of ramp signal 908 responsive to a decrease in the magnitude of slope signal 962, which can increase the rate of reduction of the peak inductor current across switching cycles within a ramp cycle period and decrease the average output current.

In some examples, the controller can include an amplifier (e.g., amplifier 916) having an output coupled to a capacitor (e.g., capacitor 1302), and the amplifier can charge the capacitor to generate the ramp signal that ramps up with time, such as shown in FIG. 13. The amplifier can include a transconductance amplifier to provide slope signal 962 as a current. The amplifier can set the current based on a voltage difference between error signal 932 and current threshold signal 960. The voltage difference can reduce for a heavier load condition where error signal 932 is close to current threshold signal 960, and the voltage difference can increase for a light load condition where error signal 932 is far away from current threshold signal 960. Accordingly, the controller can charge the capacitor with a relatively large current and increase the slew rate of the ramp signal under a very light load condition (e.g., as shown in FIG. 12), and charge the capacitor with a relatively small current and reduce the slew rate of the ramp signal under a light load condition (as shown in FIGS. 10 and 11). In some examples, the controller can include a DAC, such as shown in FIG. 14, to generate ramp signal 908.

In operation 1910, the controller can provide a current target signal based on the ramp signal and the error signal. For example, amplifier 914 can generate current target signal 934 by subtracting ramp signal 608 from error signal 932, so that current target signal 934 ramps down with time at the same ramp/slew rate as ramp signal 908.

In operation 1912, the controller can compare the current target signal with the current sense signal to generate a first decision. The first decision can indicate whether the inductor current is equal to (or above) a current target represented by current target signal 934/error signal 932.

In operation 1914, the controller can provide a first switching signal to the power converter responsive to the first decision. Specifically, the controller can set the first switching signal to a first state if the first decision indicates that the inductor current is below the current target. Also, the controller can set the first switching signal to a second state if the first decision indicates that the inductor current is equal to (or above) the current target. Power stage 102 can be turned on, and the inductor can be in the charging state, responsive to the first switching signal having the first state. Also, power stage 102 can be turned off, and the inductor can be in the discharging state, responsive to the first switching signal having the second state. Because of the target current reduces with time, the peak inductor current also reduces across the switching cycles and at a rate that reflects the load condition.

Referring back to operation 1906, if the light load condition is not satisfied (e.g., error signal 932 is above current threshold signal 960), the controller can proceed to operation 1918 and generate a flat/static current target signal based on the error signal, and compare the current sense signal with the flat current sense signal to generate a second decision, in operation 1920. Specifically, responsive to the slope signal being in the disabled state, ramp generation circuit 918 can generate a flat or zero ramp signal 908, and amplifier 914 can provide a flat current target signal 934 representing error signal 932. The second decision can indicate whether the inductor current is equal to (or above) a current target represented by current target signal 934/error signal 932.

In operation 1922, the controller can provide a second switching signal to the power converter responsive to the second decision. Specifically, the controller can set the second switching signal to a first state if the second decision indicates that the inductor current is below the current target. Also, the controller can set the second switching signal to a second state if the second decision indicates that the inductor current is equal to (or above) the current target. Power stage 102 can be turned on, and the inductor can be in the charging state, responsive to the second switching signal having the first state. Also, power stage 102 can be turned off, and the inductor can be in the discharging state, responsive to the second switching signal having the second state. Because of the flat current target, the peak inductor current can be constant across multiple switching cycles.

In this description, the term “couple” may cover connections, communications or signal paths that enable a functional relationship consistent with this description. For example, if device A provides a signal to control device B to perform an action, then: (a) in a first example, device A is directly coupled to device B; or (b) in a second example, device A is indirectly coupled to device B through intervening component C if intervening component C does not substantially alter the functional relationship between device A and device B, so device B is controlled by device A via the control signal provided by device A.

In this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described herein as including one or more semiconductor elements (such as transistors), one or more passive elements (such as resistors, capacitors and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end-user and/or a third party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in series or in parallel between identical two nodes as the single resistor or capacitor.

Uses of the phrase “ground voltage potential” in this description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described examples, and other examples are possible, within the scope of the claims.

What is claimed is:

1. An apparatus comprising:
an amplifier having a reference input, a power converter feedback input, and an amplifier output;
a ramp generation circuit having a ramp slope control terminal and a ramp signal terminal, the ramp slope control terminal coupled to the amplifier output; and
a comparator having a current sense input, a ramp signal input, and a comparator output, in which the ramp signal input is coupled to the ramp signal terminal, and the comparator output is coupled to a power converter control terminal.

2. The apparatus of claim 1, wherein the ramp generation circuit is configured to:
provide a first signal at the ramp signal terminal responsive to a second signal at the ramp slope control terminal; and
set a ramp rate of the first signal based on a magnitude of the second signal.

3. The apparatus of claim 2, wherein the ramp generation circuit is configured to set the ramp rate inversely to the magnitude of the second signal.

4. The apparatus of claim 2, wherein the amplifier is a first amplifier, the amplifier output is a first amplifier output, and the apparatus further comprises a second amplifier having a second amplifier output and first and second amplifier inputs, the first amplifier input coupled to the first amplifier output, the second amplifier input coupled to the ramp signal terminal, the second amplifier output coupled to the ramp signal input, and the second amplifier configured to provide a third signal at the second amplifier output representing a difference between a fourth signal at the first amplifier output and the first signal.

5. The apparatus of claim 4, wherein the second amplifier is configured to provide the third signal based on subtracting the first signal from the fourth signal.

6. The apparatus of claim 4, wherein the ramp generation circuit has a clock input, and the ramp generation circuit is configured to provide the first signal responsive to a clock signal at the clock input.

7. The apparatus of claim 6, wherein the clock input is a first clock input, the clock signal is a first clock signal, and the apparatus further comprises a driver circuit having a data input, a second clock input, and a data output, the data input coupled to the comparator output, the data output coupled to the power converter control terminal, and the driver circuit configured to set a state of the power converter control terminal responsive to a state of the comparator output and a second clock signal at the second clock input.

8. The apparatus of claim 7, wherein the first clock signal has a first frequency, and the second clock signal has a second frequency higher than the first frequency.

9. The apparatus of claim 7, wherein the driver circuit includes a flip-flop circuit having a reset input coupled to the data input.

10. The apparatus of claim 6, wherein the amplifier is a first amplifier, the amplifier output is a first amplifier output, and the apparatus further comprises a second amplifier having a second amplifier output and first and second amplifier inputs, the second amplifier output coupled to the ramp slope control terminal, the first amplifier input coupled to the first amplifier output, and the second amplifier input coupled to a load threshold terminal; and
wherein the ramp generation circuit includes:
a capacitor having a first plate and a second plate, the first plate coupled to the ramp slope control terminal and the ramp signal terminal, and the second plate coupled to a ground terminal; and
a switch coupled between the first and second plates, the switch having a control terminal coupled to the clock input.

11. The apparatus of claim 10, wherein the second amplifier includes a transconductance amplifier configured to provide a current at the second amplifier output as the second signal responsive to a difference between the fourth signal and a load threshold signal at the load threshold terminal.

12. The apparatus of claim 11, wherein the ramp generation circuit is configured to set the ramp rate of the first signal to zero responsive to the second signal having a larger magnitude than the load threshold signal.

13. The apparatus of claim 1, wherein the ramp generation circuit includes a digital-to-analog converter (ADC) having a digital input and an analog output, the digital input coupled to the ramp slope control terminal, and the analog output coupled to the ramp signal terminal.

14. An apparatus comprising:
a power converter having a power input, a power output, a current sense output, and a control input; and
a controller having a control output, a feedback voltage input, a reference voltage input, and a current sense input, the control output coupled to the control input, the feedback voltage input coupled to the power output, the current sense input coupled to the current sense output, and the controller including:
an amplifier having an amplifier output and first and second amplifier inputs, the first amplifier input coupled to the reference voltage input, and the second amplifier input coupled to the feedback voltage input;
a ramp generation circuit having a ramp slope control terminal and a ramp signal terminal, the ramp slope control terminal coupled to the amplifier output; and
a comparator having a comparator output and first and second comparator inputs, the first comparator input coupled to the current sense input, the second comparator input coupled to the ramp signal terminal, and the comparator output coupled to the control output.

15. The apparatus of claim 14, wherein the ramp generation circuit is configured to:
provide a first signal at the ramp signal terminal responsive to a second signal at the ramp slope control terminal; and
set a ramp rate of the first signal inversely with a magnitude of the second signal.

16. The apparatus of claim 15, wherein the ramp generation circuit has a clock input, and the ramp generation circuit is configured to provide the first signal responsive to a clock signal at the clock input.

17. The apparatus of claim 16, wherein the controller has a load threshold terminal, the amplifier is a first amplifier, the amplifier output is a first amplifier output, and the apparatus further comprises a second amplifier having a second amplifier output and third and fourth amplifier inputs, the second amplifier output coupled to the ramp slope control terminal, the third amplifier input coupled to the first amplifier output, and the fourth amplifier input coupled to the load threshold terminal; and
wherein the ramp generation circuit includes:
a capacitor having a first plate and a second plate, the first plate coupled to the ramp slope control terminal and the ramp signal terminal, and the second plate coupled to a ground terminal; and
a switch coupled between the first and second plates, the switch having a control terminal coupled to the clock input.

18. The apparatus of claim 17, wherein the second amplifier includes a transconductance amplifier configured to provide a current as the second signal at the second amplifier output responsive to a difference between a third signal at the first amplifier output and a load threshold signal at the load threshold terminal.

19. A method comprising:
receiving a current sense signal representing a current through a switch of a power converter;
generating an error signal indicating a load condition;
responsive to the error signal indicating that a light load condition is satisfied:
generating a ramp signal having a ramp rate based on the error signal;
generating a current target signal based on subtracting the ramp signal from the error signal;
comparing the current target signal with the current sense signal to generate a decision; and
providing a switching signal to the power converter responsive to the decision.

20. The method of claim 19, wherein the ramp rate has an inverse relationship with the error signal.

21. The method of claim 19, wherein the decision is a first decision, the switching signal is a first switching signal, and the method further comprises, responsive to the error signal indicating that a light load condition is satisfied:
generating a flat current target signal based on the error signal;
comparing the flat current target signal with the current sense signal to generate a second decision; and
providing a second switching signal to the power converter responsive to the second decision.
